(19) United States
(12) Patent Application Publication
(10) Pub. No.: US 2026/0153065 A1
(43) Pub. Date: Jun. 4, 2026

(54) STANDING NORMAL DETONATION JET ENGINE AND METHOD OF PRODUCING A STANDING NORMAL DETONATION WAVE

(71) Applicant: University of Central Florida Research Foundation, Inc., Orlando, FL (US)

(72) Inventors: Kareem Ahmed, Orlando, FL (US); Adam Kotler, Orlando, FL (US); Mason Thornton, Orlando, FL (US); Zachary White, Orlando, FL (US)

(21) Appl. No.: 18/958,964

(22) Filed: Nov. 25, 2024

Related U.S. Application Data
(60) Provisional application No. 63/625,413, filed on Jan. 26, 2024.

(51) Int. Cl. F02K 9/52; F02K 9/62

(52) U.S. Cl. CPC F02K 9/52; F02K 9/62

(57) ABSTRACT

The present disclosure is directed to a standing normal detonation wave jet engine (STANDJET) and systems and methods for generating a standing normal detonation wave. The STANDJET is configured to produce and sustain a standing normal detonation wave through the injection of fuel at supersonic speeds into an inlet air flow between Mach 4 and Mach 6. The STANDJET and method include injecting fuel into the inlet air in an amount to generate an equivalence ratio of 0.1 to 3.0. In addition, the inlet air speed is equal to or slightly greater than the CJ consumption speed of the detonation. Some embodiments include fuel injector ports each having a diameter of about 0.010 inches to about 0.050 inches and an annular wedge disposed in or upstream of the detonation chamber.

### PRIORITY INFORMATION

This nonprovisional application claims priority to provisional application No. 63/625,413, entitled “Standing Normal Detonation Jet Engine and Method of Producing a Standing Normal Detonation Wave,” filed Jan. 26, 2024, by the same inventor(s).

### FEDERALLY SPONSORED RESEARCH OR DEVELOPMENT

This invention was made with Government support under Grant No. FA9550-19-1-0322 awarded by the Air Force Office of Scientific Research and Grant No. W911NF-20-1-0280 awarded by the United States Army. The government has certain rights in the invention.

### BACKGROUND OF THE INVENTION

### 1. Field of the Invention

This invention relates, generally, to detonation engines. More specifically, it relates to a standing normal detonation jet engine (STANDJET) and a method of creating a standing normal detonation wave.

### 2. Brief Description of the Prior Art

Detonation, a shock coupled reaction, is a key form of combustion due to the high energy release (exergy).

This mode of combustion increases thermodynamic cycle efficiencies (˜10-20%) while reducing inlet complexities and flow path lengths of propulsion systems. Thus, detonation-based combustion systems are desired for propulsion and power systems due to their ability to provide high thermal efficiency and enable supersonic flight. Although detonations exhibit many benefits, the unsteady nature of the phenomenon presents significant challenges for practical implementation and system integration.

To date, the most common form of detonation stabilization is an oblique detonation wave (ODW). The ODW is formed when a high Mach flow, greater that the CJ detonation speed, generates a strong oblique shock on an anchoring-device (e.g., ramp) behind which an induction region and the incipient reaction is coupled resulting in the ODW. A key requirement for the ODW to form is the freestream flow Mach number must be orders of magnitude higher than the CJ detonation speed requiring significantly high Mach numbers.

The pursuit of stabilized detonations at moderate Mach numbers has been explored by Nicholls and Debora where they observed a shock-induced combustion phenomena of hydrogen-air mixtures using a Mach disk generated from Mach 3 under-expanded jet.¹ Downstream the nozzle-exit, the under-expanded flow accelerated forming a Mach disk at the intersections of intercepting shocks. They observed a change in the axial position of the Mach disk as a result of the heat release. The observed change in Mach disk location is indicative of the shock-flame coupling. From the experimental imaging, it is presumed that this coupling is a formation of a Zeldovich-Neumann-Doring (ZND) detonation.² However, agreement between the reported experimental measurements and ZND theory through quantitative analysis is not demonstrated. Additionally, the reported experimental Mach number and flow velocity conditions to the normal shock are low to support the opposing momentum generated by the detonation. In other words, the predicted CJ Mach number of the mixture composition is an order of magnitude higher compared to the incoming flow Mach number supporting the notion that what is observed in the Nicholls and Debora experiments is a standing shock-induced combustion not a standing detonation.

In view of the art considered as a whole at the time the present invention was made, it was not obvious to those of ordinary skill in the field of this invention how to produce a standing normal detonation wave or a standing normal detonation jet engine (STANDJET).

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### BRIEF SUMMARY OF THE INVENTION

The present invention relates to detonation engines and, more specifically, to a detonation engine configured to produce a stable, standing normal detonation wave. The invention provides an efficient means of delivering fuel and oxidizer to a detonation chamber at optimized ratios and speeds, which enables the creation of a controlled detonation wave. By utilizing specific configurations of fuel injectors, oxidizer inlets, and other parameters, the invention achieves stable combustion with improved power output and efficiency, offering a substantial improvement over existing detonation engine technologies.

The detonation engine includes a detonation chamber in fluidic communication with a source of an oxidizer and a source of a fuel. An oxidizer inlet is configured to direct the oxidizer to the detonation chamber and a fuel injector is configured to deliver fuel to the detonation chamber. The fuel injector and oxidizer inlet are configured to deliver the fuel and the oxidizer to the detonation chamber in a stoichiometric oxidizer/fuel equivalence ratio of about 0.1 to about 3.0 to create a detonation wave. In addition, the oxidizer inlet is configured to direct the oxidizer to the detonation chamber at a speed that is equal to or about 10 percent greater than a CJ consumption speed of the detonation wave. The resulting detonation in the detonation chamber is a standing detonation wave in a generally normal orientation relative to a longitudinal of the detonation chamber.

In some embodiments, the CJ consumption speed of the detonation wave is between about Mach 4 to about Mach 6.

In some embodiments, an annular wedge is disposed in or upstream of the detonation chamber with an angle of about 5 degrees to about 50 degrees relative to the longitudinal axis of the detonation chamber.

In some embodiments, the oxidizer is oxygen. In some embodiments, the oxidizer is ambient air and the stoichiometric oxidizer/fuel equivalence ratio is between about 0.5 and 2.0.

The fuel injector may include a plurality of fuel injector ports each having a diameter of about 0.010 inches to about 0.050 inches. In addition, the mass flow rate ratio of fuel to oxidizer is between about 0.126 and about 0.214. Moreover, the invention may include a jet momentum ratio of fuel to oxidizer that is between about 0.51 and about 0.86.

The method of the present invention includes producing a standing normal detonation wave in an engine by injecting an oxidizer and a fuel into a detonation chamber at a stoichiometric oxidizer/fuel equivalence ratio of 0.1 to 3.0. The fuel and/or mixture of the fuel and the oxidizer are ignited to create a detonation wave in the detonation chamber. The oxidizer is directed into the detonation wave at a speed that is equal to or 10% greater than a CJ consumption speed of the detonation wave. In addition, the oxidizer/fuel equivalence ratio and the speed of the oxidizer relative to the CJ consumption speed of the detonation wave are maintained thereby causing the detonation wave to reside in a generally normal orientation relative to a longitudinal of the detonation chamber.

In some embodiments, the engine further includes a fuel injector disposed in or upstream of the detonation chamber with a plurality of fuel injector ports each having a diameter of about 0.010 inches to about 0.050 inches and/or the engine includes an annular wedge disposed in or upstream of the detonation chamber at an angle of about 5 degrees to about 50 degrees relative to the longitudinal axis of the detonation chamber.

In some embodiments, the CJ consumption speed is between about Mach 4 and about Mach 6. The method may further include adjusting the oxidizer/fuel equivalence ratio until the CJ consumption speed is between about Mach 4 and about Mach 6. In addition, the method may further include adjusting the speed of the oxidizer until the detonation wave becomes a normal standing detonation wave relative to the longitudinal axis of the detonation chamber.

In some embodiments, the oxidizer is oxygen. In some embodiments, the oxidizer is ambient air and the stoichiometric oxidizer/fuel equivalence ratio is between about 0.5 and 2.0.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

For a fuller understanding of the invention, reference should be made to the following detailed description, taken in connection with the accompanying drawings, in which:

FIG. 1 is a figure of a prior art system and findings for the first oblique detonation wave.³

FIG. 2 is a schematic of detonation regimes.

FIG. 3A is a cross-sectional view of an embodiment of a STANDJET.

FIG. 3B is a cross-sectional view of an embodiment of an injector and a combustion chamber of a STANDJET.

FIG. 3C is a cross-sectional view of an embodiment of an injector and a combustion chamber of a STANDJET.

FIG. 4A is a perspective view of an embodiment of an injector for a STANDJET.

FIG. 4B is a side view of an exemplary propellant injector.

FIG. 4C is a cross-sectional view of an exemplary propellant injector.

FIG. 4D is a close-up cross-sectional view of Detail B from FIG. 4C.

FIG. 5 is a cross-sectional view of an embodiment of a STANDJET.

FIG. 6 is a cross-sectional view of an embodiment of a STANDJET.

FIG. 7 is a vector representation of the inlet speed and consumption speed for a SNDW.

FIG. 8A is a flowchart of an embodiment of the method of the present invention.

FIG. 8B is a flowchart of an embodiment of the method of the present invention.

FIG. 8C is a flowchart of an embodiment of the method of the present invention.

FIG. 9 is a representative image of a hypersonic reaction facility, including the preburner, converging-diverging nozzle, and optically accessible test section with a wedge reaction stabilizer.

FIG. 10 is picture of a detonation wave using schlieren and chemiluminescence imaging showing a standing normal detonation wave.

FIG. 11 is a graph of the shock and heat release captured during experimentation and compared to the theoretical computation.

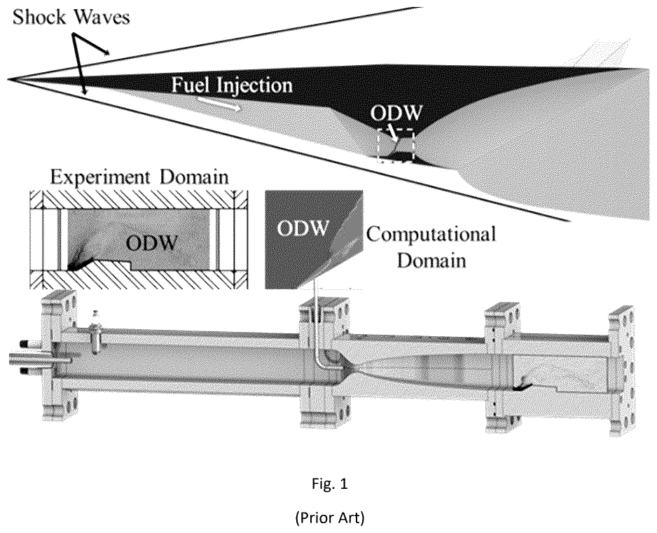

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

All numerical designations, such as measurements, efficacies, physical characteristics, forces, and other designations, including ranges, are approximations which are varied up or down by increments of 1.0 or 0.1, as appropriate. It is to be understood, even if it is not always explicitly stated that all numerical designations are preceded by the term “about.” As used herein, “about” or “approximately” refers to being within an acceptable error range for the particular value as determined by one of ordinary skill in the art, which will depend in part on how the value is measured or determined. As used herein, the term “about” refers to +10% of the numerical; it should be understood that a numerical including an associated range with a lower boundary of greater than zero must be a non-zero numerical, and the term “about” should be understood to include only non-zero values in such scenarios.

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

The phrases “in some embodiments,” “according to some embodiments,” “in the embodiments shown,” “in other embodiments,” and the like generally mean the particular feature, structure, or characteristic following the phrase is included in at least one implementation. In addition, such phrases do not necessarily refer to the same embodiments or different embodiments.

The term “propellant” as used herein refer to chemical substances that undergo rapid combustion or decomposition to produce high-pressure, high-temperature gases, which generate thrust. Propellants include a fuel component and an oxidizer component, which are combined to create an explosive reaction when ignited.

The term “oxidizer” as used herein refers to a chemical substance that provides oxygen or another electronegative element to the fuel, enabling it to burn. Non-limiting examples of oxidizers include ambient air, oxygen, liquid oxygen (LOX), nitrogen tetroxide, and ammonium perchlorate.

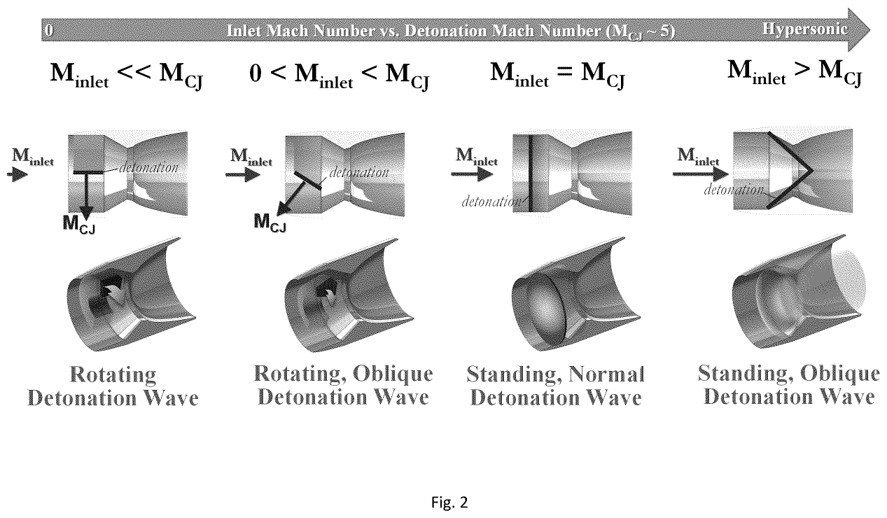

Currently, there are four theories of detonation modes as shown in FIG. 2. In moving from left to right in FIG. 2, the first detonation mode is a rotating detonation wave. The second detonation mode is an oblique rotating detonation wave (ORDW) produced in a supersonic oblique rotating detonation wave engine (SORDE). The third detonation mode is a standing normal detonation wave (SNDW) produced in a standing normal detonation jet engine (STANDJET). Finally, the fourth detonation mode is a standing, oblique detonation wave. The first mode is a traditional rotating detonation wave in which the inlet Mach number is subsonic and very low relative to the consumption/detonation wave speed, e.g., the internal inlet speed has a Mach number between 0.01 and 0.5 when the consumption speed has a Mach number between 5 and 6. The second mode includes a faster inlet speed that is still less than the consumption speed, e.g., the inlet flow speed has a Mach number between 1.2 and 6 when the consumption speed has a Mach number between 5-6. The third mode is where the incoming flow velocity is equal to or slightly greater than the consumption speed (e.g., Mach 4-6) forming a nearly orthogonal stationary wave. The fourth mode is a stationary oblique detonation where the detonation is confined and restricted by the inlet high-Mach flow (e.g., between Mach 6-17) and the ramp forcing the formation of the oblique detonation wave at an oblique angle to balance the velocity decomposition of the incoming flow.

The present invention includes a STANDJET and a system and method for producing an SNDW, i.e., a system and method for producing the third mode described above. As previously noted, the inlet flow speed (also referred to as the “inlet flow Mach number”) is equivalent to or slightly higher than the Chapman-Jouguet (CJ) consumption speed of a SNDW. This allows the detonation wave to form and stabilize in a normal orientation relative to the incoming air flow. Typically, the consumption speed for an SNDW is about Mach 4 to Mach 6 for producing sufficient thrust with known fluidic propellants. Thus, the incoming airflow for the STANDJET and for the method of producing a SNDW will also reside between Mach 4 and Mach 6 in such situations.

The STANDJET includes an inner detonation chamber in which the SNDW is developed and sustained and an exhaust port through which the explosive energy is directed to produce thrust. The STANDJET further includes a fuel injector configured to direct fuel upstream or into the detonation chamber. In addition, the STANDJET includes one or more air inlet ports configured to intake ambient air and/or an oxidizer injector to direct oxygen (or an oxygen mixture) into or upstream of the detonation chamber. The oxidizer injector could be separate or integrated with the fuel injector. Some embodiments further include additional structures, as will be described in further detail below, to improve the mixing of the air and fuel and/or to create or anchor the SNDW.

As noted above, the system and method for producing a supersonic SNDW and/or a STANDJET is based on combining the ideal flow conditions of the propellants (fuel and oxidizer) and may include one or more ramps/wedges creating a front-end angle or bluntness to induce the ignition and formation of the SNDW. Balancing the high-Mach propellant mixture of the inlet flow relative to the CJ consumption speed of the detonation wave is critical for forming and sustaining the SNDW. This critical balance results in a shock that is coupled with the reactions behind it forming the detonation and energy release mechanism. Based on the fuel injection which prevents the detonation from propagating upstream relative to the incoming supersonic flow to hypersonic flow (which is equivalent to or slightly greater than, e.g., 10% greater than, the detonation consumption speed), a standing detonation forms at nearly 90 degrees relative to the incoming flow to balance the velocity decomposition of the incoming flow. Put another way, in order to achieve a stabilized standing normal detonation, two criteria must be met: (1) the reaction kinetic rates of the mixture composition must be sufficiently fast to enable auto-ignition within the flow residence time of a detonation, t_{ind-experiment}=t_{ind-ZND}, and (2) the freestream inlet propellant Mach number has to be equivalent to the CJ detonation Mach number, M_{flow}=M_{CJ}.

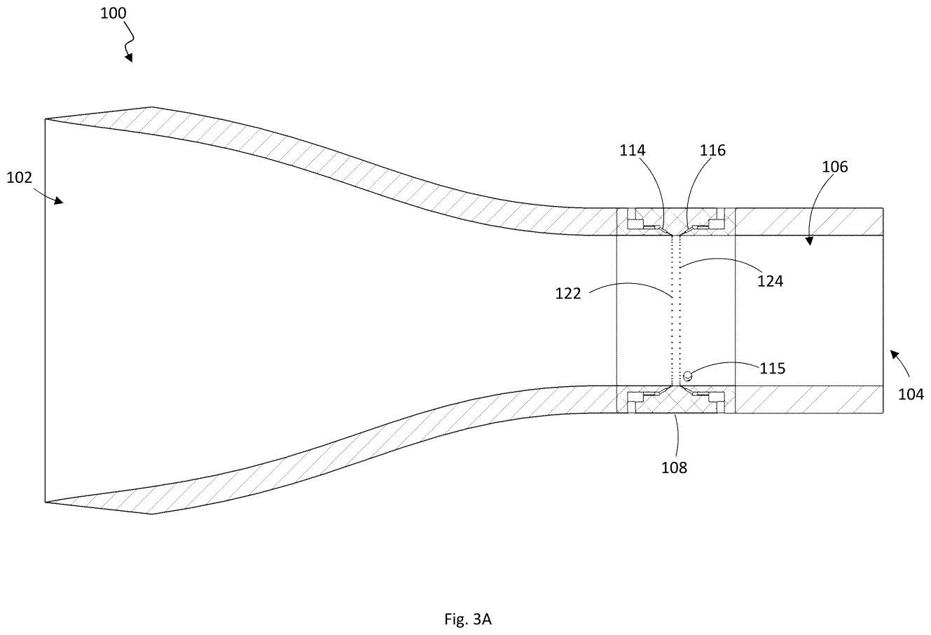

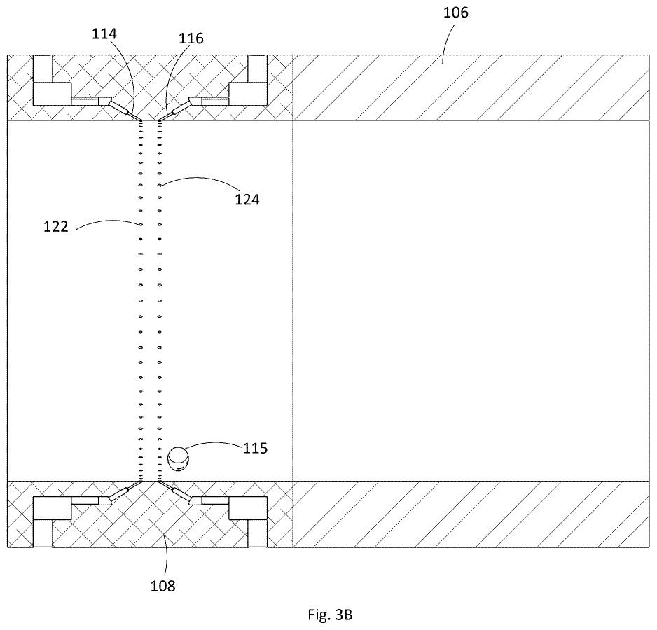

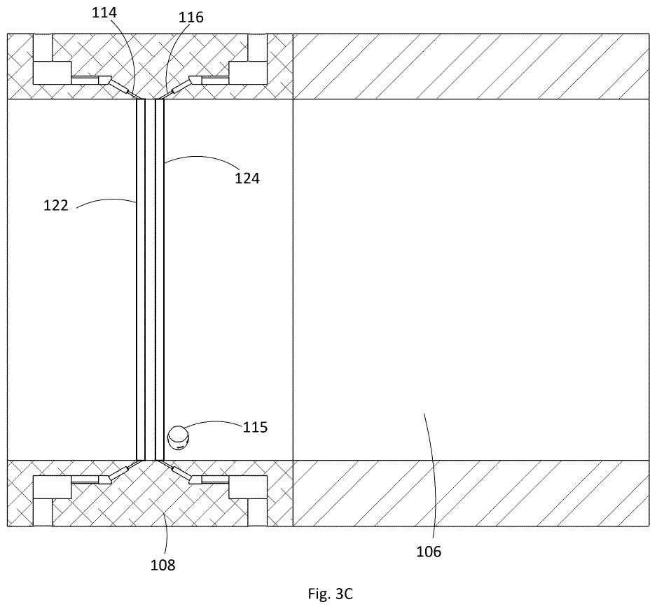

Referring now to FIGS. 3, an embodiment of the STANDJET 100 includes an inlet port 102 and an outlet port 104. The inlet port 102 leads to a propellant injector 108 and an inner detonation chamber 106. The propellants-fuel (e.g., hydrogen) and an oxidizer (e.g., oxygen, ambient air, or an oxygen mixture)—are mixed and detonated using an igniter 115 to create and sustain the SNDW in the detonation chamber 106. The explosive energy of the SNDW is directed to the exhaust port 104 to produce thrust.

The propellant injector 108 is configured to direct fuel upstream or into the detonation chamber 106. The STANDJET 100 uses one or more air inlet ports 102 configured to intake ambient air and/or an oxidizer injector to direct an oxidizer into or upstream of the detonation chamber 106. In some embodiments, a fuel injector and an oxidizer injector are combined as a single propellant injector, which is exemplified by propellant injector 108 in FIG. 3. However, the oxidizer injector can be separate from the fuel injector. In addition, the STANDJET 100 can rely solely on one or more air inlet ports 102 to deliver ambient air as the oxidizer to the combustion chamber 106.

In some embodiments, the propellant injector 108 includes an array of fuel injector nozzles 114 arranged about the internal circumference of the propellant injector 108 for injecting a predetermined amount of fuel into the inlet oxidizer and/or injected oxidizer to establish a stoichiometric air/fuel equivalence ratio of 0.5 to 2.0 or a stoichiometric oxygen/fuel equivalence ratio of 0.1 to 3.0. In some embodiments, the propellant injector 108 has an annular array of fuel injector nozzles 114 each with outlet aperture 122 having a diameter of about 0.010 inches to about 0.050 inches to generate the specified fuel-air or stoichiometric oxygen/fuel equivalence ratio. In some embodiments, the present invention includes an annular array of fuel injector nozzles 114 each with an outlet aperture diameter of about 0.010 inches to about 0.040 inches to generate the specified equivalence ratio. The number, size, and spacing of fuel injector nozzles 114 and apertures 122 relative to the number, size, and spacing of oxidizer inlet ports 102 or nozzles 116 and apertures 124 can be varied so that the mixture of fuel and oxidizer results in a stoichiometric air/fuel equivalence ratio of 0.5 to 2.0 or a stoichiometric oxygen/fuel equivalence ratio of 0.1 to 3.0. In some embodiments, the propellant injector 108 is configured to have a pitch/distance between the fuel injector nozzles 114 that is about 0.001″ to about 0.47″.

In some embodiments, the propellant injector 108 has one or more fuel injector nozzles 114 delivering fuel through a circumferentially extending, slot-shaped aperture 122 as depicted in FIG. 3C. Likewise, the propellant injector 108 may have one or more oxidizer injector nozzles 116 delivering fuel through a circumferentially extending, slot-shaped aperture 124.

Moreover, while the depicted embodiment shows the fuel injectors 116 and fuel apertures or slot 124 at a downstream location relative to the oxidizer injector 114 and oxidizer apertures or slot 122, the orientation may be flipped so that the fuel injectors 116 and fuel apertures or slot 124 are at an upstream location relative to the oxidizer injector 114 and oxidizer apertures or slot 122.

In some embodiments, the fuel injector nozzles 114 are configured to direct fuel into the incoming air stream at a predetermined angle and a predetermined flowrate to ensure proper mixing. With respect to the longitudinal axis of the engine, the fuel injector nozzles 114 are directed at relative angles of about 25 degrees to about 90 degrees. In some embodiments, the fuel injector nozzles 114 are directed at angles of about 5-90 degrees relative to the longitudinal axis of the engine.

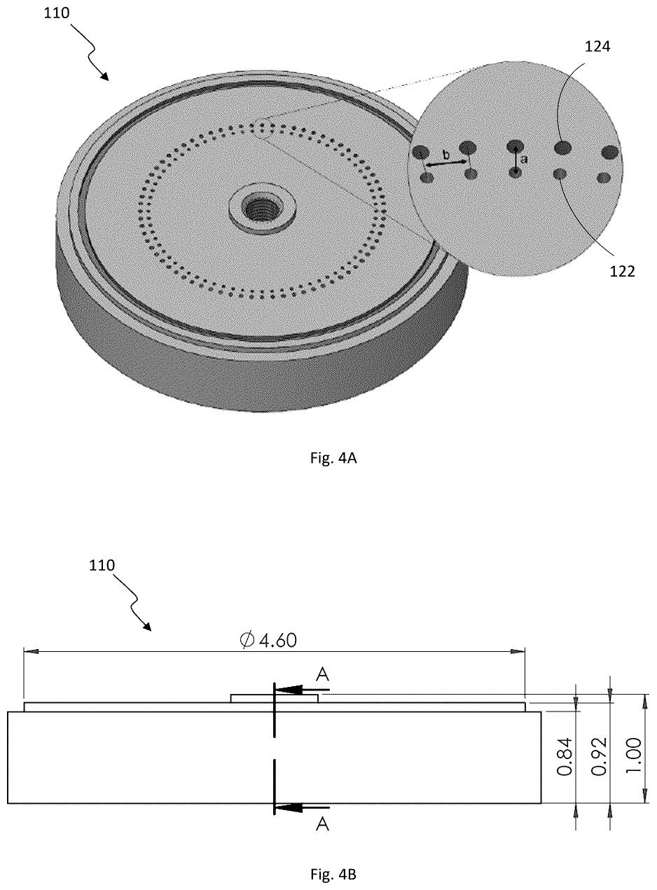

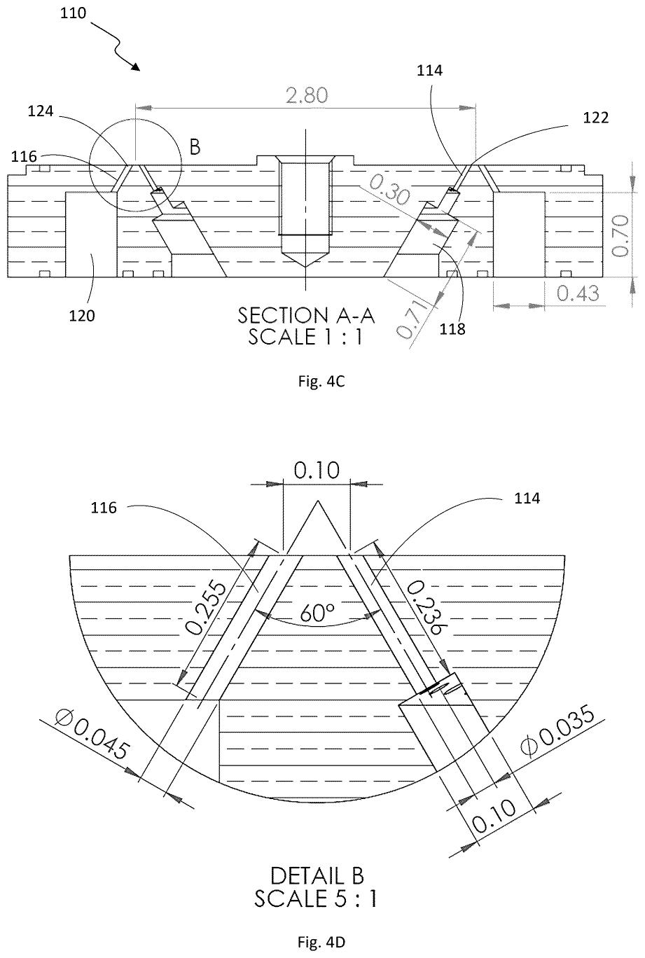

FIG. 4 depicts an embodiment of a propellant injector 110 that has a closed fore end, which is typical of rockets intended for space flight. As depicted, the propellant injector 110 includes an array of fuel and oxidizer injector nozzles 114 and 116 configured to direct propellant into an annulus-shaped detonation chamber. In some embodiments, there are 72 injector pairs (fuel nozzles 114 and oxidizer nozzles 116) arrayed in a circumferential pattern.

The various parameters of embodiments of the propellant injector 110 are listed in Table 1; however, these parameters can be scaled up to a larger diameter STANDJET for higher flow rates and these parameters can apply to the propellant injector 108 in FIG. 3.

| | |
|---|---|
| Hydrogen | Oxygen |
| (Fuel, F) | (Oxidizer, O) |

| | |
|---|---|
| Injector Diameter | 1.2-1.4 |

| | | |
|---|---|---|
| (DO/DF) | | |
| Injector Length by | 6-7 | 5-6 |
| Injector Diameter | | |
| (I/D) | | |

| | |
|---|---|
| Interior Angle | 55-65° |
| Number of Injector Pairs | 2000-2200 per unit inch |

by Injector Diameter
(N/DF)

| | |
|---|---|
| Injector Pair Spacing by | 2.5-2.7 |

Injector Diameter
(a/DF)

| | |
|---|---|
| Injector Pair Spacing by | 3.3-3.6 |

Injector Diameter
(b/DF)

| | |
|---|---|
| Pressure Ratio | 0.8775-1.4917 |

(PF/PO)

| | |
|---|---|
| Mass Flow Ratio | 0.1263-0.2147 |

(mF/mO)

| | |
|---|---|
| Annulus Width by | 5.5-5.9 |

Injector Diameter
(Cw/DF)

| | |
|---|---|
| Annulus Diameter by | 14-16 |

Annulus Width
(CA/Cw)

| | |
|---|---|
| Jet Momentum Ratio | 0.51-0.86 |

(pF/pO)

As shown in FIGS. 4, the propellant injector 110 may include an impinging doublet injection scheme with micronozzle injector channels 114 and 116 that choke the fluid propellant flow as it passes through the injector outlet apertures 122 and 124, thereby regulating the flow rate of propellants as they enters the detonation chamber 106. In some embodiments, the interior angle between the impinging doublet nozzle configuration is 60°. In some embodiments, the interior angle between the impinging doublet nozzle configuration is between 55° and 65°.

While the depicted embodiment includes 72 discrete injector pairs arrayed in a circumferential pattern about the injector, the number of pairs may be increased or decreased depending on the size of the STANDJET. In some embodiments, the ratio of injector pair spacing in a radial direction by injector diameter is between 2.5 and 2.7. In some embodiments, the ratio of injector pair spacing in a circumferential direction by injector diameter is between 3.3 and 3.6.

Moreover, this injector pattern is meant to sit between an inner and outer body which forms the boundary for the combustor annulus on the detonation chamber 106. Thus, the nozzle locations and the number of nozzle pairings will correspond to the size of the STANDJET and in turn the diameter of the detonation chamber 106. In some embodiments, the ratio of the number of injector pairs by injector diameter is between 2000 and 2200 per unit inch.

Each nozzle pair 114, 116 includes a fuel injector nozzle 114 of a generally circular cross section and an oxidizer injector nozzle 116 of similar circular cross section. In some embodiments, the injector diameters, D, are about 0.035 inches and about 0.045 inches for the fuel and oxidizer injector apertures 122, 124, respectively. In some embodiments, the ratio of the oxidizer injector diameter to the fuel injector diameter is between about 1.2 and about 1.4.

In some embodiments, the injector contour for both the fuel and oxidizer injectors is a simple cylindrical channel 114 and 116. However, the shape and cross-sectional shape of the channels may have alternative shapes.

Some embodiments further include a specific length to diameter ratio for the injector channels. For example, the l/d ratio may be between 6.468 and 5.695 for the fuel and oxidizer, respectively. In some embodiments, the l/d ratio for the fuel injector is between 6 and 7, and the l/d ratio for the oxidizer injector is between 5 and 6.

In some embodiments, the sizing of the nozzle diameters maintains an equivalent pressure upstream of the injector 110 at favorable flow conditions of the STANDJET for a similar geometry, thereby maintaining similar jet momentums between both propellants and therefore the best mixing conditions for detonation. More specifically, the mass flow rate ratio of fuel to oxidizer can be between 0.1263-0.2147 and the jet momentum ratio of fuel to oxidizer can be between 0.51 and 0.86.

Some embodiments of the STANDJET injector are further tailored to the parameters of a STANDJET annulus. For example, the ratio of annulus width to injector diameter is between 5.5 and 5.9 and the ratio of annulus diameter to annulus width is 14-16.

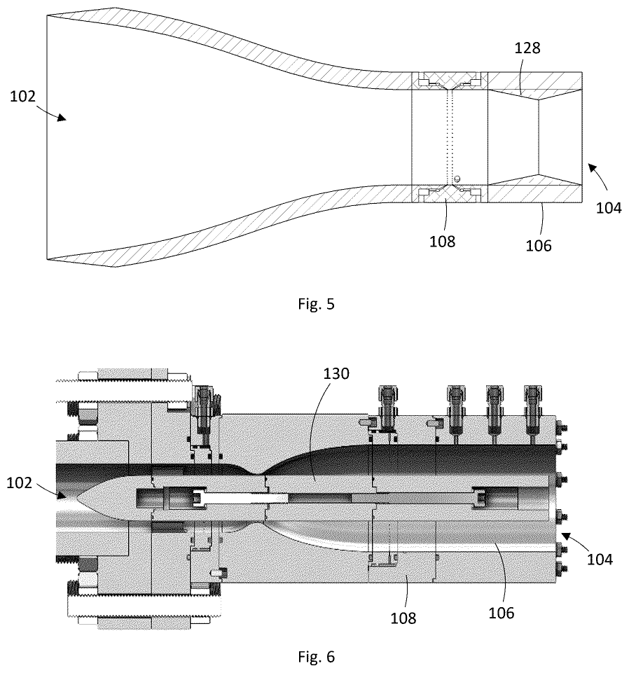

Some embodiments of the present invention, as depicted in FIG. 5, further include a shock-anchoring device, such as, wedge or ramp structure 128 within the engine to aid in mixing and provide a structure from which the SNDW is formed and supported. Some embodiments may use a plurality of discontinuous ramps arranged about the circumference of the internal surface of the detonation chamber. There may be two diametrically opposed ramps or a plurality of equally spaced ramps about the circumference of the detonation chamber. When a plurality of ramps is used, they are sufficiently arranged about the circumference of the detonation chamber to induce the ignition and formation of the standing normal detonation.

In some embodiments the ramp or wedge angle is between about 5 degrees and about 50 degrees. In some embodiments the ramp or wedge angle is between about 10 degrees and about 30 degrees. In some embodiments, the ramp(s) are configured to adjust inclination dynamically based on the inlet fluid speed and/or the detonation speed of the detonation wave.

As depicted in FIG. 6, some embodiments of the present invention include a center cylindrical body 130 that establishes an annular shaped detonation channel 106 and helps to create and maintain the detonation.

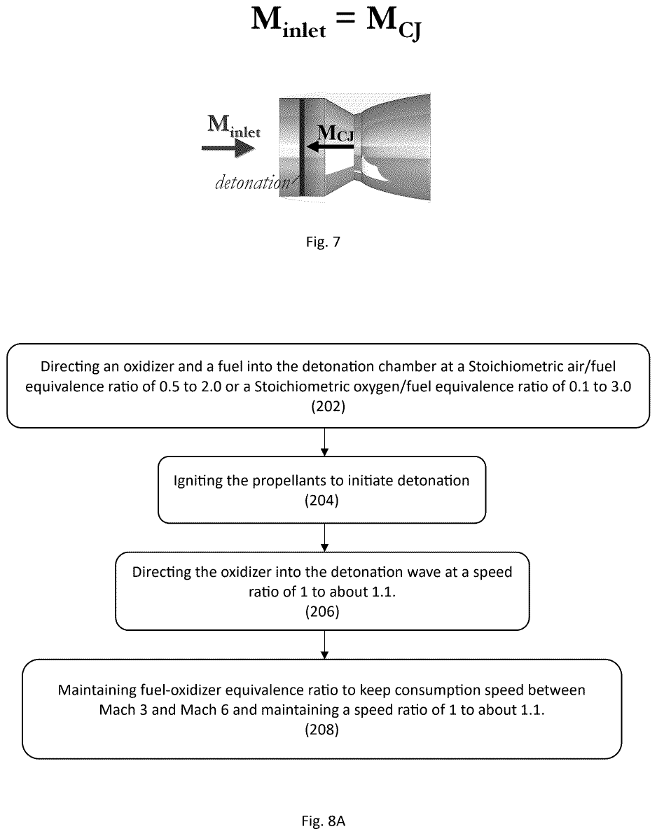

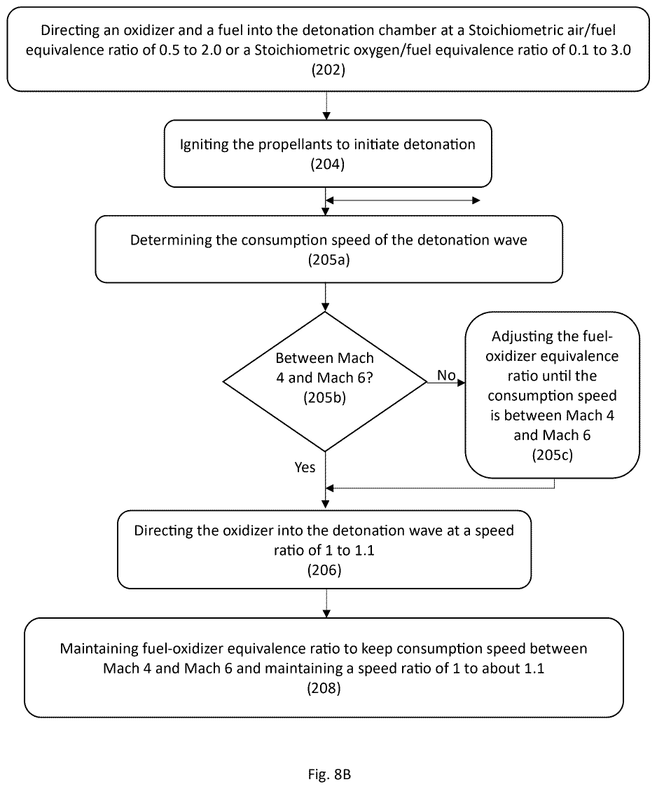

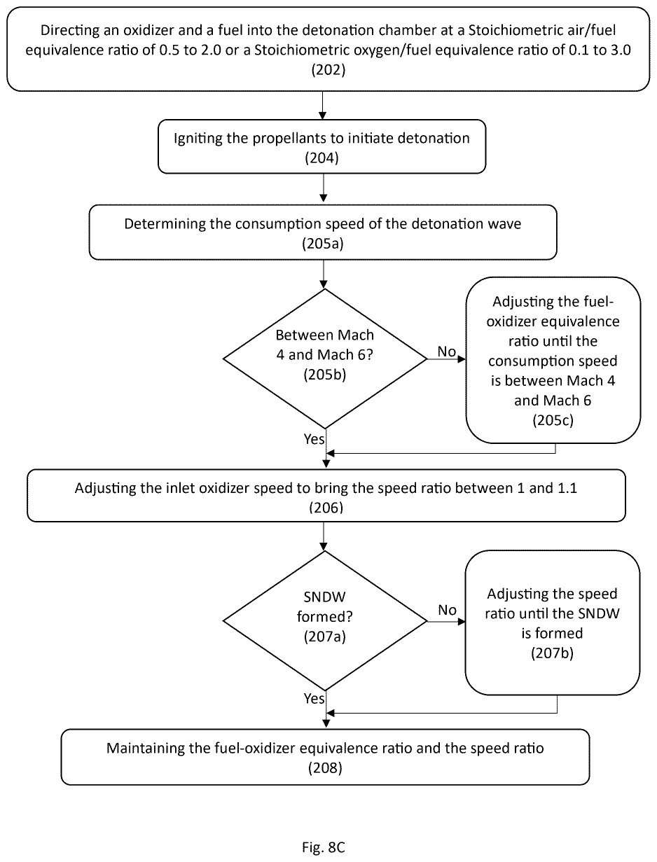

Referring now to FIGS. 7-8, balancing the high-Mach propellant mixture of the inlet flow relative to the CJ consumption speed of the detonation is critical for creating and sustaining the SNDW. As shown in FIG. 7, the variable Minlet represents the speed or Mach number of the inlet flow and the variable Mcr represents the CJ consumption speed of the detonation. These variables can be represented as velocity vectors and are roughly equal to create a SNDW. This critical balance results in a shock that is coupled with the turbulent reactions behind it forming the detonation and energy release mechanism.

The system and method for producing a supersonic SNDW and/or a STANDJET is also based on combining the ideal flow conditions of the injection fueling, and as previously noted, may include the central cylindrical structure 130 and/or a ramp or wedge 128 to create a front-end angle or bluntness to induce the ignition and formation of the rotating detonation. Referring now to FIGS. 8, the present invention includes a method of creating and maintaining SNDW in an engine. The method includes directing an oxidizer (e.g., air, oxygen, or a mixture of oxygen and other gases) and a fuel (e.g., hydrogen) into the detonation chamber at a stoichiometric air/fuel equivalence ratio of 0.5 to 2.0 or a stoichiometric oxygen/fuel equivalence ratio of 0.1 to 3.0 at step 202. In some embodiments, the fuel is hydrogen and/or the oxidizer is air, oxygen, or a mixture of oxygen and other gases.

The method further includes igniting the propellants (i.e., the mixture of the fuel and oxidizer) to initiate the detonation at step 204. The oxidizer is directed into the detonation at a ratio of inlet speed to consumption speed that is between 1 to 1.1 to create the standing normal detonation wave at step 206. In some embodiments, the inlet oxidizer speed is sufficiently adjusted in step 206 to create a ratio of inlet oxidizer speed to wave/consumption speed (the “speed ratio”) that is between 1 to 1.1. In some embodiments, the inlet oxidizer speed is between Mach 3 and Mach 6 when the consumption/wave speed is between Mach 3 and Mach 6. In some embodiments, the inlet oxidizer speed is between Mach 4 and Mach 6 when the consumption/wave speed is between Mach 4 and Mach 6.

The inlet oxidizer can be provided by the ambient environment through an inlet port or can be provided by an oxidizer injector configured to provide the inlet oxidizer between Mach 4 and Mach 6 or in a speed ratio that is between 1 to 1.1. Thus, some embodiments include specific nozzle designs (e.g., converging or converging-diverging nozzles) for injecting or altering the speed of the inlet oxidizer from an inlet port or an oxidizer nozzle. In addition, the inlet nozzle or port may be dynamically adjustable to alter the inlet fluid speed as needed to reach the necessary flow speed of Mach 4 to Mach 6. Regardless of the design, the STANDJET of the present invention is configured to deliver the inlet oxidizer to the detonation chamber at a speed ratio that is between 1 to 1.1.

Some embodiments as depicted in FIG. 8B, include optional steps 205a-205c. At step 205a, the consumption/wave speed of the detonation is determined. Step 205b includes identifying if the CJ consumption speed is within Mach 4 to Mach 6. If not, then step 205c is performed, which includes adjusting the oxidizer/fuel equivalence ratio until the CJ consumption speed of the detonation wave is between Mach 4 and Mach 6. Step 205c may be accomplished by adjusting the flowrate of the oxidizer, the flowrate of the fuel, or both. Steps 205 may further include a step of measuring or identifying the CJ consumption speed of the detonation wave after adjusting the oxidizer/fuel equivalence ratio to achieve the desired consumption speed.

Referring now to FIG. 8C, some embodiments of the method further includes steps 207. Step 207a includes determining if an SNDW is formed in the detonation chamber. If not, the speed ratio is adjusted at step 207b until the SNDW is formed. The speed ratio is adjusted by altering the speed of the incoming oxidizer and/or adjusting the oxidizer/fuel equivalence ratio to alter the CJ consumption speed. Once the speed ratio and oxidizer/fuel equivalence ratio create the SNDW, they are both maintained to sustain the SNDW as desired.

### Experimentation:

During testing, the system and method disclosed herein produced a reaction-coupled standing normal detonation wave in a hypersonic reacting facility.

### Methodology

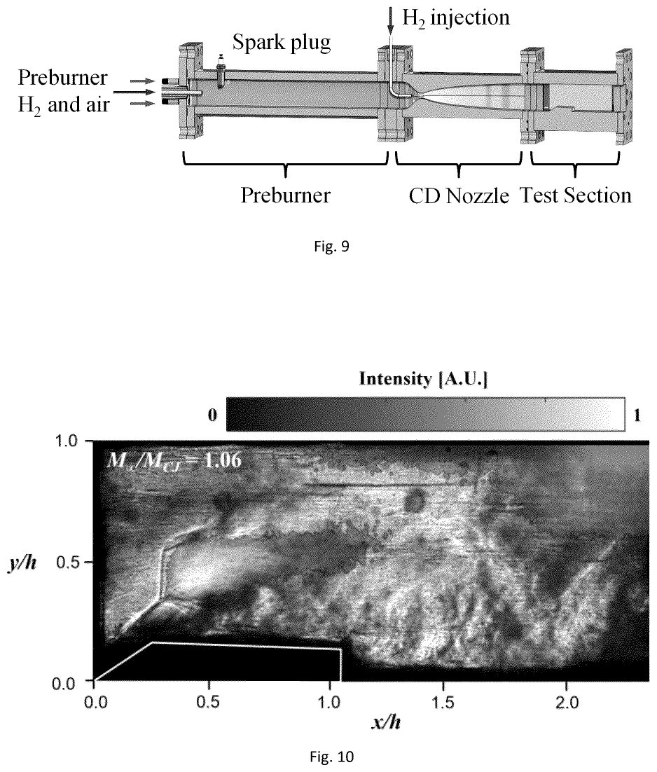

Experiments were conducted in a high enthalpy hypersonic reacting facility, presented in FIG. 9. The facility includes an upstream H₂-air preburner to reach stagnation temperatures and pressures of T₀=800-1200 K and P₀=3.6-6.1 MPa. The preburner was operated over a range of lean equivalence ratios and ignited with a spark plug. The flow was accelerated to supersonic conditions with a converging-diverging (CD) nozzle with an exit-to-throat area ratio of A/A*=25. Additional H₂ was injected into the vitiated products at the nozzle throat. Following the CD nozzle was the optically accessible test section, which included a 2D-wedge to initiate detonations.

The testing conditions explored are provided in Table 1 below:

TABLE 1
Experimental testing conditions. The mole fractions of major species and freestream
properties of the mixture entering the test section are also provided.

| Φ_{PB} | P₀ (MPa) | T₀(K) | χ_{H2} | χ_{O2} | χ_{N2} | χ_{H2O} | M_{∞} | T_{∞} (K) | P_{∞} (kPa) | Φ_{TS} |
|---|---|---|---|---|---|---|---|---|---|---|
| 0.45 | 5.2 | 1237 | 0.19 | 0.09 | 0.58 | 0.14 | 4.52 | 315 | 14.5 | 1.07 |

As provided in Table 1, Φ_{PB} is the preburner equivalence ratio, P₀ (MPa) is the stagnation pressure, To (K) is the stagnation temperature, XH₂ is the hydrogen mole fraction, χ_{O2} is the oxygen mole fraction, χ_{N2} is the nitrogen mole fraction, χ_{H2O} is the water mole fraction, M_{∞} is the freestream Mach number, T_{∞}(K) is the freestream temperature, P_{∞} (kPa) is the free stream pressure, and Φ_{TS} is the test section equivalence ratio.

The equivalence ratio of the H₂-air mixture in the preburner and the resulting stagnation properties are documented. The mixture composition of the vitiated products with the added H₂ is documented by the mole fractions in the table. The mixture flowed through the CD nozzle and was accelerated to a freestream Mach number (M_{∞}) with a corresponding freestream temperature (T_{∞}) and pressure (P_{∞}) and entered the test section. The test section equivalence ratio is also provided, and is based only on the H₂—O₂ in the mixture as:

$${ϕ}_{T S} = \frac{{\dot{m}}_{{H}_{2}} / {\dot{m}}_{{O}_{2}}}{{( {\dot{m}}_{{H}_{2}} / {\dot{m}}_{{O}_{2}} )}_{stoich}} \qquad ( 1 )$$

Simultaneous 30 kHz Schlieren imaging and chemiluminescence imaging were used to visualize shock structures and the reaction, respectively. The Schlieren system was set up in a Z-formation, with two spherical mirrors (1.52 m focal length) and an LED light source (Luminus PT-121-G). The Schlieren imaging was captured on a high-speed CMOS camera (Photron SAZ) equipped with a Nikon 70-300 mm lens. The chemiluminescence system consisted of an SAZ camera equipped with a Nikon 50 mm focal length lens. Additional details of the imaging systems are provided in previous work.³

### Results and Discussion

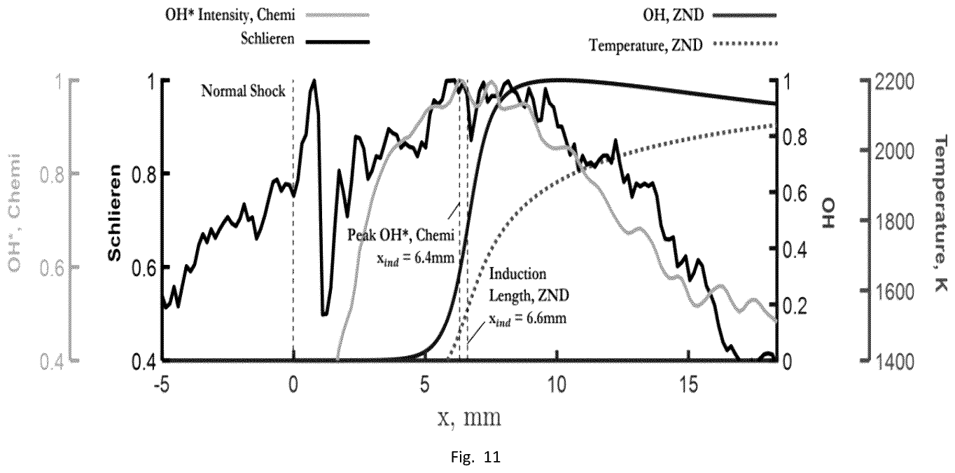

The testing condition resulted in a standing normal detonation wave, as depicted in FIGS. 10-11. The normal shock was visualized with schlieren imaging, and was overlayed with a contour of the OH* from the reaction. The formation of the standing normal detonation occurred when the flow Mach number M_{flow} was on the order of the consumption speed of the detonation, M_{CJ}. The ramp formed an oblique shock anchored to the ramp leading edge and coalesced with the normal detonation aiding the stabilization.

An analytical solution of the 1-D ZND detonation structure was performed using the experimentally measured flow boundary conditions as inputs to the model. The gas state model inputs were specified as the pre-shock state properties, which were the test-section flow boundary conditions. The reaction mechanism used in the ZND analysis is from Mevel.⁴ The model provides the 1-D structure of the normal detonation which is comparable here to the experimental standing normal detonation.

FIG. 11 presents the ZND-predicted induction length, temperature, and OH overlaid against the experimental schlieren gradient depicting the shock front and chemiluminescence OH* intensity along the axial distance. The average spatial separation between the shock and the reaction front is 6.4 mm. This measurement is close to the calculated ZND-induction length of 6.6 mm, thereby satisfying criteria (1) required of stable standing detonations.

Criteria (2) was satisfied when the flow Mach number is equivalent to the CJ detonation Mach number. For a stationary detonation, the detonation Mach number will be equivalent to the freestream Mach number at the test section inlet, M_{flow}=4.3. The ZND CJ detonation Mach number, which was calculated using the known inlet temperature, pressure, and mixture composition was found to be M_{CJ}=4.05.1 This resulted in a Mach number ratio of M_{flow}/M_{CJ}=1.06, which provides strong evidence of the realized standing normal detonation mode of combustion. Therefore, SNDWs can be realized over a regime of lower Mach numbers in comparison to oblique detonation waves at higher Mach numbers.

### REFERENCES

1. J. A. Nicholls, E. K. Dabora, Recent results on standing detonation waves, Symp. (Int.) Combust. 8 (1961) 644-655.
2. Y. B. Zeldovich, On the theory of the propagation of detonation in gaseous systems, Zh. Eksp. Teoret. Fiz. 10 (1940) 542-568.
3. D. A. Rosato, M. Thornton, J. Sosa, C. Bachman, G. B. Goodwin, K. A. Ahmed, Stabilized detonation for hypersonic propulsion, Proc. Natl. Acad. Sci. 118 (2021) 1-7.
4. R. Mevel, K. Chatelain, G. Blanquart, J. E. Shepherd, An updated reaction model for the high-temperature pyrolysis and oxidation of acetaldehyde, Fuel 217 (2018) 226-239.

All referenced publications are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A detonation engine, comprising:
a detonation chamber in fluidic communication with a source of an oxidizer and a source of a fuel;
an oxidizer inlet configured to direct the oxidizer to the detonation chamber;
a fuel injector configured to deliver fuel to the detonation chamber;
wherein the fuel injector and oxidizer inlet are configured to deliver the fuel and the oxidizer to the detonation chamber in a stoichiometric oxidizer/fuel equivalence ratio of about 0.1 to about 3.0 to create a detonation wave;
wherein the oxidizer inlet is configured to direct the oxidizer to the detonation chamber at a speed that is equal to or about 10 percent greater than a CJ consumption speed of the detonation wave;
whereby the resulting detonation in the detonation chamber is a standing detonation wave in a generally normal orientation relative to a longitudinal axis of the detonation chamber.

2. The engine of claim 1, wherein the CJ consumption speed of the detonation wave is between about Mach 4 to about Mach 6.

3. The engine of claim 1, wherein the oxidizer is oxygen.

4. The engine of claim 1, wherein the oxidizer is ambient air and the Stoichiometric oxidizer/fuel equivalence ratio is between about 0.5 and 2.0.

5. The engine of claim 1, further including an annular wedge disposed in or upstream of the detonation chamber, wherein the annular wedge has an angle of about 5 degrees to about 50 degrees relative to the longitudinal axis of the detonation chamber.

6. The engine of claim 1, wherein a mass flow rate ratio of fuel to oxidizer is between about 0.126 and about 0.214.

7. The engine of claim 1, wherein a jet momentum ratio of fuel to oxidizer is between about 0.51 and about 0.86.

8. The engine of claim 1, wherein the fuel injector includes a plurality of fuel injector ports each having a diameter of about 0.010 inches to about 0.050 inches.

9. A method of producing a standing normal detonation wave in an engine, comprising:
injecting an oxidizer and a fuel into a detonation chamber at a stoichiometric oxidizer/fuel equivalence ratio of 0.1 to 3.0;
igniting the fuel to create a detonation wave in the detonation chamber;
directing the oxidizer into the detonation wave at a speed that is equal to or 10% greater than a CJ consumption speed of the detonation wave; and
maintaining the oxidizer/fuel equivalence ratio and the speed of the oxidizer relative to the CJ consumption speed of the detonation wave thereby causing the detonation wave to reside in a generally normal orientation relative to a longitudinal axis of the detonation chamber.

10. The method of claim 9, wherein the engine further includes a fuel injector disposed in or upstream of the detonation chamber, wherein the fuel injector includes a plurality of fuel injector ports each having a diameter of about 0.010 inches to about 0.050 inches.

11. The method of claim 9, wherein the engine further includes an annular wedge disposed in or upstream of the detonation chamber, wherein the annular wedge has an angle of about 5 degrees to about 50 degrees relative to the longitudinal axis of the detonation chamber.

12. The method of claim 9, wherein the CJ consumption speed is between about Mach 4 and about Mach 6.

13. The method of claim 9, further including adjusting the oxidizer/fuel equivalence ratio until the CJ consumption speed is between about Mach 4 and about Mach 6.

14. The method of claim 9, further including adjusting the speed of the oxidizer until the detonation wave becomes a normal standing detonation wave relative to the longitudinal axis of the detonation chamber.

15. A method of producing a standing normal detonation wave in an engine, comprising:
injecting an oxidizer and a fuel into a detonation chamber;
igniting the fuel to create a detonation wave in the detonation chamber;
adjusting a stoichiometric oxidizer/fuel equivalence ratio between 0.1 to 3.0 until the detonation wave has a CJ consumption speed between about Mach 4 and about Mach 6;
directing the oxidizer into the detonation wave at a speed ratio that is between 1 and 1.1, wherein the speed ratio is a ratio of a speed of the oxidizer relative to the CJ consumption speed of the detonation wave; and
maintaining the oxidizer/fuel equivalence ratio and the speed ratio to cause the detonation wave to maintain a generally normal orientation relative to a longitudinal axis of the detonation chamber.

16. The method of claim 15, wherein the engine further includes an annular wedge disposed in or upstream of the detonation chamber, wherein the annular wedge has an angle of about 5 degrees to about 50 degrees relative to the longitudinal axis of the detonation chamber.

17. The method of claim 15, further including adjusting the oxidizer/fuel equivalence ratio until the CJ consumption speed is between about Mach 4 and about Mach 6.

18. The method of claim 15, further including adjusting the speed of the oxidizer until the detonation wave becomes a normal standing detonation wave relative to the longitudinal axis of the detonation chamber.

19. The method of claim 15, wherein the oxidizer is oxygen.

20. The method of claim 15, wherein the oxidizer is ambient air and the stoichiometric oxidizer/fuel equivalence ratio is between about 0.5 and 2.0.
